(19) United States
(12) Patent Application Publication
(10) Pub. No.: US 2016/0078639 A1
(43) Pub. Date: Mar. 17, 2016

(54) COMPUTING DEVICE AND METHOD FOR CALCULATING AREA OF OUTLINE OF OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); TAO TAO, Shenzhen (CN); ZONG-TAO YANG, Shenzhen (CN)

(21) Appl. No.: 14/584,528

(22) Filed: Dec. 29, 2014

(30) Foreign Application Priority Data
Sep. 11, 2014 (CN) 201410460655.7

(51) Int. Cl. G06T 7/60; G06K 9/46

(52) U.S. Cl. CPC G06T 7/602; G06K 9/4652; G06K 9/4638

(57) ABSTRACT

A method calculates an area of an outline of an object using a computing device. The object is placed on a platform of the measurement machine connected to the computing device. The computing device obtains outline points of the object from an image of the object captured by the measurement machine. The computing device triangulates the outline points of the object using multiple triangles and generates an outline of the object. The computing device calculates the area of the outline of the object according to an area of each triangle.

### CROSS-REFERENCE TO RELATED APPLICATIONS

This application claims priority to Chinese Patent Application No. 201410460655.7 filed on Sep. 11, 2014, the contents of which are incorporated by reference herein.

### FIELD

The subject matter herein generally relates to image technology, and particularly to a computing device and a method for calculating an area of an outline of an object.

### BACKGROUND

There is a specific formula for calculating an area of a regular shape, such as a triangle, a cube, a rectangle, a circle or the like. However, there may not exist a specific formula for calculating an area of an irregular shape.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device connected to a measurement machine.

FIG. 2 shows a diagrammatic view of an example of the measurement machine in FIG. 1.

FIG. 3 is a block diagram of an example embodiment of an area measurement system included in the computing device.

FIG. 4 shows a diagrammatic view of an example of an outline of an object.

FIG. 5 shows a diagrammatic view of an example of triangulating outline points of the outline of the object.

FIG. 6 shows a diagrammatic view of an example of a chart which shows areas of outlines.

FIG. 7 is a flowchart of an example embodiment of a method for calculating an area of the outline of the object.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

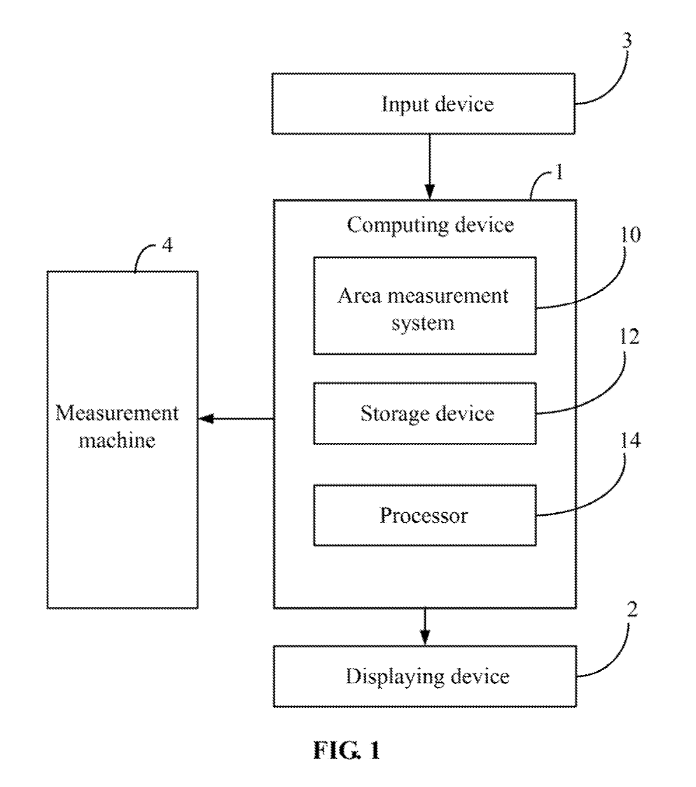

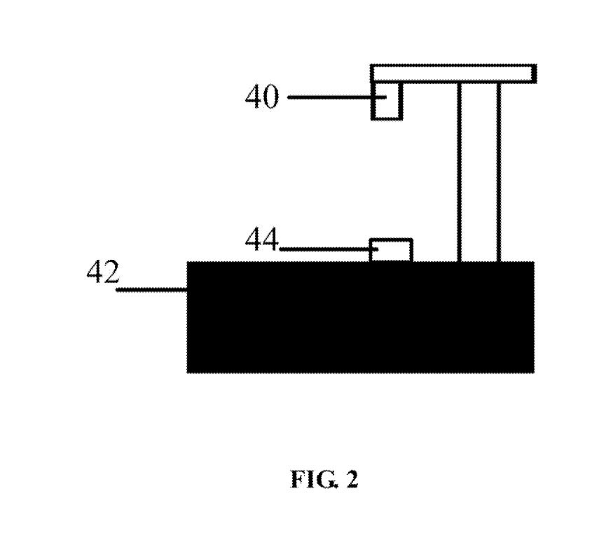

FIG. 1 illustrates a block diagram of an example embodiment of a computing device 1. In the embodiment, the computing device 1 provides various functional connections to connect with a display device 2, an input device 3, and a measurement machine 4. The computing device 1 provides a user interface, which is displayed on the display device 2. One or more operations of the computing device 1 can be controlled by a user through the user interface. For example, the user can input an ID and a password using the input device 3 (e.g., a keyboard and a mouse) into the user interface to access the computing device 1. The measurement machine 4 includes a charge coupled device (CCD) 40 and a platform 42, as shown in FIG. 2. The CCD 40 is used to capture an image of an object 44 which is located on the platform of the measurement machine 4. The display device 2 further displays the image of the object 44, so that the image of the object 44 can be visually checked by the user. The computing device 1 can be, but is not limited to, a tablet computer, a server, a personal computer or any other computing device. The measurement machine 4 can be, but is not limited to, a three-dimensional scanner capable of emitting light which is projected onto the object 44. In the example embodiment, the computing device 1 includes, but is not limited to, an area measurement system 10, a storage device 12, and at least one processor 14. FIG. 1 illustrates only one example of the computing device 1, and other examples can comprise more or fewer components than those shown in the embodiment, or have a different configuration of the various components.

In at least one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1.

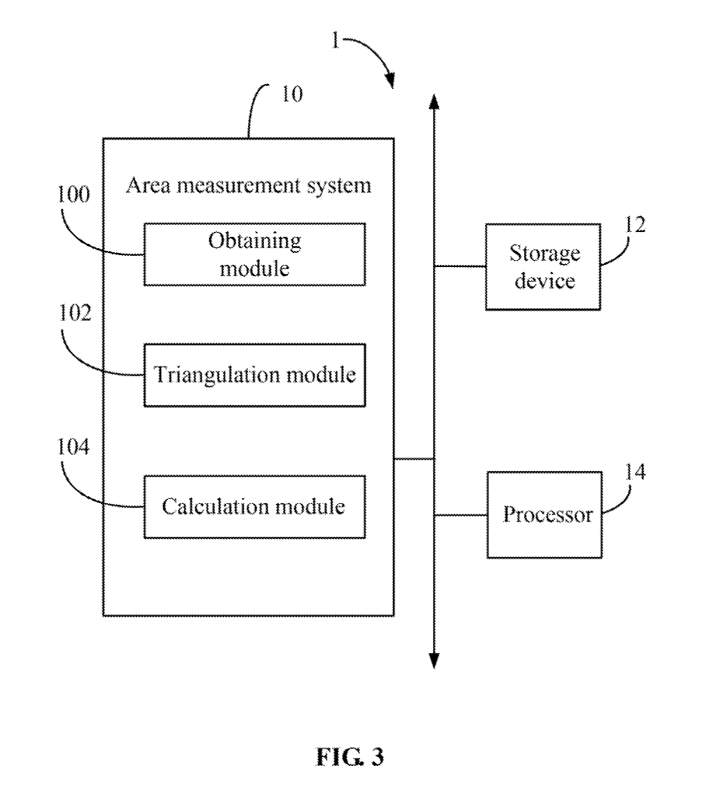

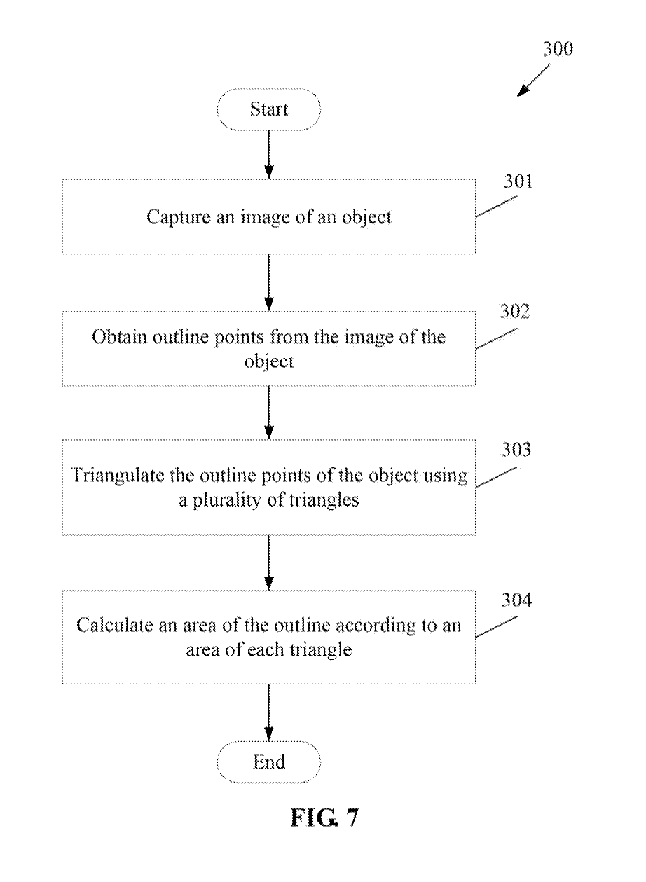

FIG. 3 illustrates a block diagram of an example embodiment of the area measurement system 10 included in the computing device 1. In at least one embodiment, the area measurement system 10 can include, but is not limited to, an obtaining module 100, a triangulation module 102, and a calculation module 104. The modules 100-104 can comprise computerized instructions in the form of one or more computer-readable programs that can be stored in a non-transitory computer-readable medium, such as the storage device 12, and be executed by the at least one processor 14 of the computing device 1. Detailed descriptions of functions of the modules are given below in reference to FIG. 7.

FIG. 7 illustrates a flowchart of an example embodiment of a method for calculating an area of an outline of an object using a computing device. In an example embodiment, the method is performed by execution of computer-readable software program codes or instructions by at least one processor of the computing device.

Referring to FIG. 7, a flowchart is presented in accordance with an example embodiment. The method 300 is provided by way of example, as there are a variety of ways to carry out the method. The method 300 described below can be carried out using the configurations illustrated in FIGS. 1-6, for example, and various elements of these figures are referenced in explaining example method 300. Each block shown in FIG. 7 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

At block 301, a obtaining module obtains an image of an object from an measurement machine. In at least one embodiment, the object is positioned on a platform of the measurement machine, and a CCD of the measurement machine captures the image of the object and sends the image of the object to a computing device.

At block 302, the obtaining module obtains outline points of the object from the image of the object. In at least one embodiment, the obtaining module processes the image of the object using a binary processing method to generate pixel gray values of the image of the object. The obtaining module further obtains the outline points of the object using the pixel gray values of the image of the object. For example, if a pixel gray value of the image of the object exceeds a predetermined pixel gray value (e.g., 155) which is at a range of [0, 255], the pixel gray value of the image of the object is determined as an outline point.

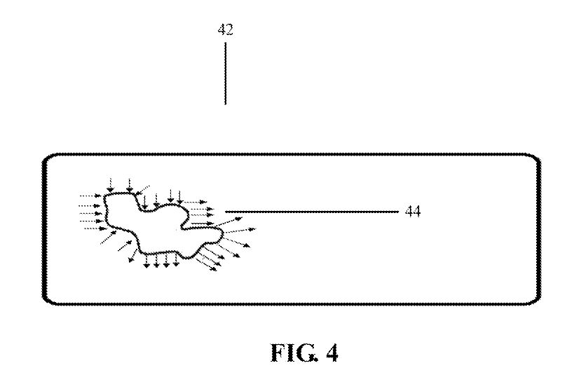

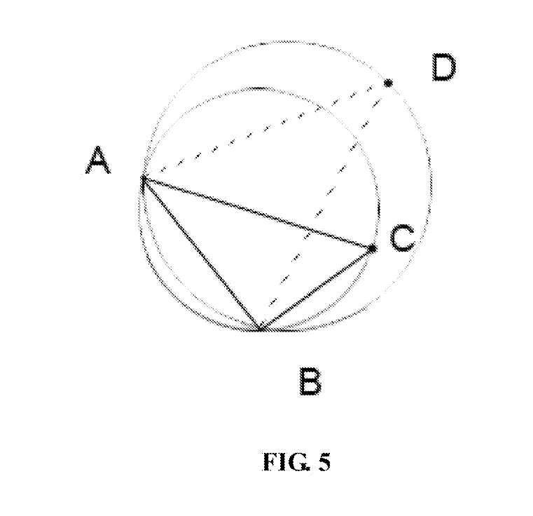

At block 303, a triangulation module triangulates the outline points of the object using a plurality of triangles and generates an outline of the object. In at least one embodiment, the outline points of the object can be represented by the plurality of triangles after triangulation. Each triangle is determined to be qualified when the triangle meets two following conditions: (1) there are no points inside a circumcircle of the triangle. For example, as shown in FIG. 5, another outline point C is located inside the circumcircle of the triangle which is generated by the outline points A, B and D, then the triangle A-B-D does not meet the first condition (1) and the triangle A-B-D is determined to be unqualified. As yet shown in FIG. 5, the triangle A-B-C meet the first condition (1), the triangle A-B-C are determined to be qualified. In addition, after triangulation there are still a lot of qualified triangles; some qualified triangles are discarded for simplifying calculations. For example, if a curvature of the qualified triangle falls in a predetermined range (e.g., 70 degrees to 90 degrees), the qualified triangle is kept. If a curvature of the qualified triangle falls in another predetermined range (e.g., 0 degree to 10 degrees), the qualified triangle is randomly selected to be kept, for example, a predetermined percentage (30%) of the qualified triangles which the curvature of each qualified triangle falls in a range of 0 degrees to 10 degrees are randomly selected to be kept. All of the triangles generate an outline of the object, as shown in FIG. 4.

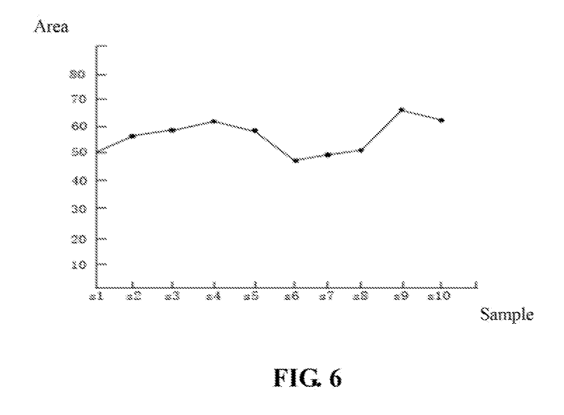

At block 304, a calculation module calculates an area of an outline of the object according to an area of each triangle. In at least one embodiment, the area of the outline of the object is a sum area of all triangles. The area of the outline of the object is calculated by a formula as follows:

$${\sum }_{i = 1}^{n} {A}_{i} = {A}_{1} + {A}_{2} + {A}_{3} + … + {A}_{n} ,$$

where n is an amount of all triangles, A is an area of the triangle. A is calculated by a formula as follows:

$${A}_{i} = \sqrt{{p}_{i} ( {p}_{i} - {a}_{i} ) ( {p}_{i} - {b}_{i} ) ( {p}_{i} - {c}_{i} )} , {p}_{i} = \frac{{a}_{i} + {b}_{i} + {c}_{i}}{2 } ,$$

where aᵢ is a first line of the i^{th} triangle, bᵢ is a second line of the i^{th} triangle, and cᵢ is a third line of the triangle, the triangle consists of the first line, the second line and the third line. As shown in FIG. 5, the triangle A-B-C consists of the first line A-B, the second line B-C, and the third line A-C. In addition, the calculation module generates a chart to show the area of the outline of the object. As shown in FIG. 6, ten objects, such as S1, S2, S3, S4, S5, S6, S7, S8, S9, S10, are measured. The computing device calculates an area of an outline of each object, and shows the area of the outline of each object in the chart as shown in FIG. 6.

The embodiments shown and a described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device comprising:
at least one processor; and
a storage device that stores one or more programs, which when executed by the at least one processor, cause the at least one processor to:
obtain an image of an object from a measurement machine coupled to the computing device;
obtain outline points of the object from the image of the object;
triangulate the outline points of the object using a plurality of triangles and generate an outline of the object; and
calculate an area of the outline of the object according to an area of each triangle of the plurality of triangles.

2. The computing device of claim 1, wherein each triangle is determined to be qualified when the triangle meets a condition that there are no outline points inside a circumcircle of the triangle.

3. The computing device of claim 1, wherein the outline points of the object are obtained by:
processing the image of the object using a binary processing method to generate pixel gray values of the image of the object; and
obtaining the outline points of the object using the pixel gray values of the image of the object.

4. The computing device of claim 3, wherein a pixel gray value of the image of the object is determined as an outline point when the pixel gray value of the image of the object exceeds a predetermined pixel gray value which is at a range.

5. The computing device of claim 1, wherein all of the triangles are used to generate the outline of the object.

6. The computing device of claim 1, wherein the area of the outline of the object is a sum area of all of the triangles.

7. A computer-based method for calculating an area of an outline of an object using a computing device, the method comprising:
obtaining an image of the object from a measurement machine coupled to the computing device;
obtaining outline points of the object from the image of the object;
triangulating the outline points of the object using a plurality of triangles and generating an outline of the object; and
calculate an area of the outline of the object according to an area of each triangle.

8. The method of claim 7, wherein each triangle is determined to be qualified when the triangle meets a condition that there are no outline points inside a circumcircle of the triangle.

9. The method of claim 7, wherein the outline points of the object are obtained by:
processing the image of the object using a binary processing method to generate pixel gray values of the image of the object; and
obtaining the outline points of the object using the pixel gray values of the image of the object.

10. The method of claim 9, wherein a pixel gray value of the image of the object is determined as an outline point when the pixel gray value of the image of the object exceeds a predetermined pixel gray value which is at a range.

11. The method of claim 7, wherein all of the triangles are used to generate the outline of the object.

12. The method of claim 7, wherein the area of the outline of the object is a sum area of all of the triangles.

13. A non-transitory computer-readable medium having stored thereon instructions that, when executed by at least one processor of a computing device, causing the computing device to perform a method for calculating an area of an outline of an object, the method comprising:
obtaining an image of the object from a measurement machine coupled to the computing device;
obtaining outline points of the object from the image of the object;
triangulating the outline points of the object using a plurality of triangles and generating an outline of the object; and
calculate an area of the outline of the object according to an area of each triangle.

14. The non-transitory computer-readable medium of claim 13, wherein each triangle is determined to be qualified when the triangle meets a condition that there are no=outline points inside a circumcircle of the triangle.

15. The non-transitory computer-readable medium of claim 13, wherein the outline points of the object are obtained by:
processing the image of the object using a binary processing method to generate pixel gray values of the image of the object; and
obtaining the outline points of the object using the pixel gray values of the image of the object.

16. The non-transitory computer-readable medium of claim 15, wherein a pixel gray value of the image of the object is determined as an outline point when the pixel gray value of the image of the object exceeds a predetermined pixel gray value which is at a range.

17. The non-transitory computer-readable medium of claim 15, wherein all of the triangles are used to generate the outline of the object.

18. The non-transitory computer-readable medium of claim 13, wherein the area of the outline of the object is a sum area of all of the triangles.
